(19) United States
(12) Patent Application Publication
(10) Pub. No.: US 2006/0091280 A1
(43) Pub. Date: May 4, 2006

(54) Flat panel display organizer and method

(76) Inventor: Wayne H. Rothschild, Northbrook, IL (US)

Correspondence Address: JENKENS & GILCHRIST, P.C., 225 WEST WASHINGTON, SUITE 2600, CHICAGO, IL, 60606, US

(21) Appl. No.: 10/980,545

(22) Filed: Nov. 3, 2004

(51) Int. Cl. B41J 11/02

(52) U.S. Cl. 248/442.2

(57) ABSTRACT

This invention provides space-saving and productivity enhancing organizational devices for use with flat panel display devices. The invention converts the typically unused space directly behind a flat panel display into highly valuable space for the placement of files and other materials, which a user may require ready access. Furthermore, it keeps these items in plain view of the user while the user is actively viewing the flat panel display. This is especially important when the flat panel display is being used in a constrained space or where desk space is limited.

### FIELD OF THE INVENTION

This invention relates generally to organizers and, more particularly, to the association of these devices with flat panel displays.

### BACKGROUND OF THE INVENTION

Traditionally, the display device for a television or a computer monitor was a screen built from a cathode ray tube (CRT). Because CRT displays were rather large, these monitors occupied a significant amount of space. Recently however, flat panel display technology has become much more affordable, and LCD, TFT, plasma, OLED, and other flat panel display devices are rapidly replacing CRT displays. One of the primary reasons that consumers prefer flat panel displays is that the flat panel displays require significantly less desktop space as compared to the CRT displays. Flat panel displays can be standalone or incorporated into a laptop computer or other device.

Organizer devices exist for use with CRT displays, but because of the volume occupied by the CRT, these devices must use the space above and beside the CRT display. There is little useful space behind a CRT display as this space is occupied by the tube.

When the flat panel display is placed on a desk, there is typically unused space behind the flat panel display. At the same time, the working space at the desk is often insufficient for all the materials needed to support the work activity. Additionally, when a laptop computer is used in a cramped environment such as an airplane, there is typically insufficient space for all the materials needed to support the work activity.

As such, an apparatus and method that utilizes the space behind a flat panel display is needed, and the present invention is directed to fulfilling this and other needs.

### SUMMARY OF THE INVENTION

The present invention uses the space behind and beside a flat panel display by providing an organizer that is adapted to receive and hold some or all of the following things: files, documents, paper, pens, pencils, notepads, paperclips, tape, staplers, mobile phones, clocks, remote controls, user manuals, guides, CDs, DVDs, and other materials. An object of this invention is to convert the unused space around the flat panel display into highly useful and productive space.

Another object of this invention is to create usable space for materials behind a flat panel display.

Still another object of this invention is to provide a resting place for important information that will be located in plain sight for top-of-mind awareness and within easy reach of the user.

As the drawings and the descriptions will show, the organizer can be separable or integrated into the flat panel display housing. In its separable configuration, the organizer's housing is attached to the flat panel display by hanging, clipping, strapping, adhering, fastening, or through mounting provisions that are integrated in the flat panel display housing. In some embodiments, the organizer is designed to fit around the base and screen of the flat panel display. In other embodiments, the organizer in integrated with the flat panel display housing. Furthermore, the organizer can be implemented such that it can be extended and retracted from the monitor housing for use as needed. Alternately in other embodiments, the organizer is freestanding and positioned behind the flat panel display.

The organizer can be configured in a multitude of ways. For example, it can include a file organizer, a shelf, a tray, a cup, or a combination of the any of the aforementioned.

### BRIEF DESCRIPTION OF THE DRAWINGS

FIG. 1A is a front view of a video display where the display screen is a conventional CRT.

FIG. 1B is a side view of a video display where the display screen is a conventional CRT.

FIG. 2A is a front view of a video display where the display screen is a flat panel display.

FIG. 2B is a side view of a video display where the display screen is a flat panel display.

FIG. 3A is a front view of an organizer which is integrated with the flat panel display assembly.

FIG. 3B is a side view of an organizer which is integrated with the flat panel display assembly.

FIG. 4 is a side view of an organizer which is removably mounted to the housing of a flat panel display assembly according to an embodiment of the present invention.

FIG. 5 is a side view of an organizer which is removably mounted to the housing of a flat panel display assembly according to another embodiment of the present invention.

FIG. 6 is a side view of an integrated organizer mounted to the flat panel display assembly where the organizer is positioned to avoid impeding access to the power supply and monitor controls of the flat panel display assembly.

FIG. 7A is a perspective view of a freestanding organizer according to an embodiment of the present invention for positioning behind a flat panel display assembly.

FIG. 7B is a side view of the organizer shown in FIG. 7A with a flat panel display assembly located on the footing of the organizer.

FIG. 7C is a perspective view of a freestanding organizer according to another embodiment of the present invention for positioning behind a flat panel display assembly.

FIG. 7D is a side view of the organizer shown in FIG. 7C with a flat panel display assembly located on the footing of the organizer.

FIG. 7E is a perspective view of a freestanding organizer according to still another embodiment of the present invention for positioning behind a flat panel display assembly.

FIG. 7F is a side view of the organizer shown in FIG. 7E with a flat panel display assembly located in the footing of the organizer.

FIG. 7G is a perspective view of a freestanding organizer according to yet another embodiment of the present invention for positioning behind a flat panel display assembly.

FIG. 7H is a side view of the organizer shown in FIG. 7G with a flat panel display assembly located in the footing of the organizer.

FIG. 7I is a perspective view of a freestanding organizer according to yet another embodiment of the present invention for positioning behind a flat panel display assembly.

FIG. 7J is a perspective exploded view of stacking blocks that provide for the height adjustability of the organizer shown in FIG. 7I.

FIG. 8A is a side view of the flat panel display located on the footing of an organizer that is adjustable vertically and horizontally to position it optimally for a particular flat panel display assembly and desk configuration.

FIG. 8B is a side view of a freestanding organizer where the organizer is placed behind a flat panel display assembly and is adjustable vertically and horizontally to position it optimally for a particular flat panel display assembly and desk configuration.

FIG. 9 is a perspective view of a freestanding organizer having adjustable feet according to an embodiment of the present invention.

FIG. 10 is a side view of the flat panel display assembly and organizer that is removably mounted to the flat panel display assembly according to an embodiment of the present invention.

FIG. 11 is a side view of a freestanding organizer having a shelf and an area for small objects including pens, pencils, scissors, and the like according to an embodiment of the present invention.

FIG. 12 is a side view of an organizer that includes a shelf mounted to the housing of a flat panel display assembly according to an embodiment of the present invention.

FIG. 13 is a side view of a flat panel display assembly with multiple removable shelves located behind the flat panel display assembly and an organizer placed on one of the shelves.

FIG. 14A is a front view of a flat panel display assembly and an organizer that extends beyond the sides of the flat panel display assembly.

FIG. 14B is a side view of the flat panel display assembly and organizer shown in FIG. 14A.

FIG. 15A is a front view of an organizer mounted to a laptop where the organizer extends above and beyond sides of the flat panel display to provide versatile access and visibility of materials stored in the organizer.

FIG. 15B is a side view of the organizer shown in FIG. 15A.

FIG. 16A is a front view of a laptop and a file organizer having integral retractable and extendable wings to hold documents according to an embodiment of the present invention.

FIG. 16B is a side view of the laptop and file organizer shown in FIG. 16A.

FIG. 16C is a perspective back view of a laptop having a zippered, expandable file organizer strapped to the display of the laptop according to an embodiment of the present invention.

FIG. 16D is a perspective front view of the laptop and file organizer shown in FIG. 16C.

FIG. 16E is a side view of the laptop and file organizer shown in FIGS. 16C and 16D.

FIG. 16F is a perspective side view of a laptop having a zippered, expandable file organizer removably attached to the laptop according to an embodiment of the present invention.

FIG. 16G is a side view of the laptop shown in FIG. 16F.

FIG. 16H is a perspective front view of a laptop in an open position surrounded by a zippered organizer case having an expandable file organizer according to an embodiment of the present invention.

16I is a perspective back view of the laptop shown in FIG. 16H showing a support stand integrated into the organizer case.

FIG. 16J are perspective front and back views of the organizer case shown in FIGS. 16H and 16I held closed by a zipper with the support stand in a retracted position against the case.

FIG. 17 is a side view of a rotatable flat panel display assembly that is viewable in a landscape or portrait orientation and an organizer according to an embodiment of the present invention.

### DETAILED DESCRIPTION OF THE INVENTION

While the present disclosure is susceptible of embodiment in various forms, there is shown in the drawings and will hereinafter be described preferred embodiments of the invention with the understanding that the present disclosure is to be considered as setting forth exemplifications of the invention which are not intended to limit the invention to the specific embodiments illustrated.

The present invention provides space-saving and productivity-enhancing organizer devices for use with flat panel display devices such as flat panel displays and laptops. The present invention converts the typically unused space directly behind a flat panel display into highly valuable space for the placement of files and other materials that a user may require ready access. Furthermore, these items are kept in plain view of the user while the user is actively viewing the flat panel display. This is especially important when the flat panel display is being used in a constrained space or where desk space is otherwise limited.

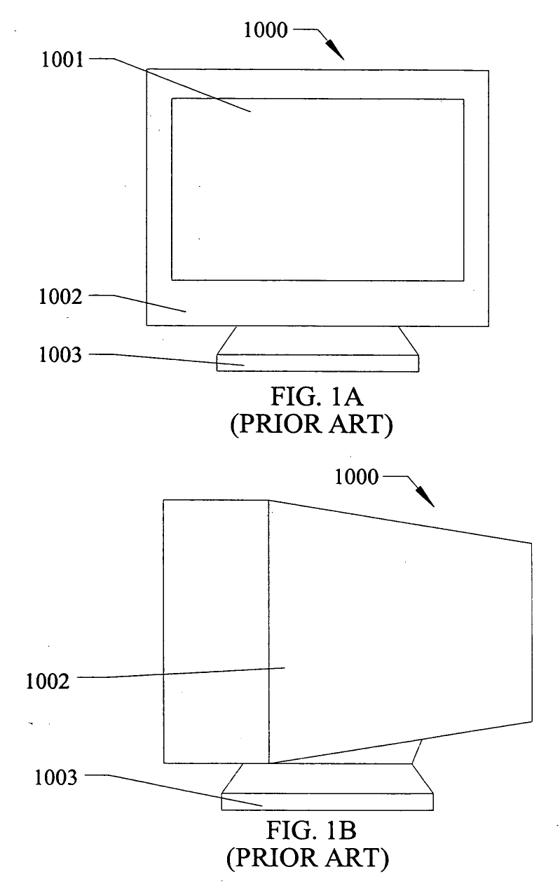

Conventionally, televisions and computer displays utilized a cathode ray tube (CRT) to display images. An example of such a conventional CRT monitor 1000 is shown in FIGS. 1A and 1B. The CRT screen 1001 is enclosed in a housing 1002 that is supported by a base 1003. FIG. 1B exemplifies a problem associated with CRT devices in that they occupy large amounts of space behind the actual display screen. Because this space is occupied by the CRT, there is no opportunity to utilize the space behind the CRT screen for storage.

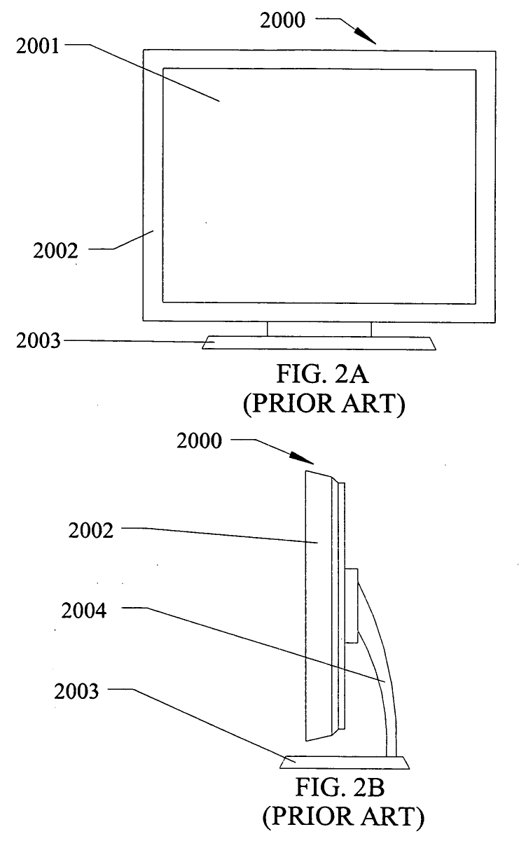

Flat panel displays have become increasingly affordable and are presently quite popular with businesses and consumers for use as computer monitors, televisions and as numerous portable computing and video entertainment devices. FIGS. 2A and 2B illustrate a flat panel display assembly 2000 that includes a flat panel display video screen 2001, a housing 2002, a base 2003, and a stand 2004. Any conventional flat panel display device can be used with any embodiment shown or described herein without departing from the spirit of the present invention.

As a comparison of FIGS. 1B and 2B reveals, flat panel displays do not suffer from the drawback of CRTs in that flat panel displays have a much smaller overall footprint than their CRT counterparts and therefore occupy substantially less space. Significantly, there is considerably more space behind the flat panel display 2000 than is available behind the CRT monitor 1000.

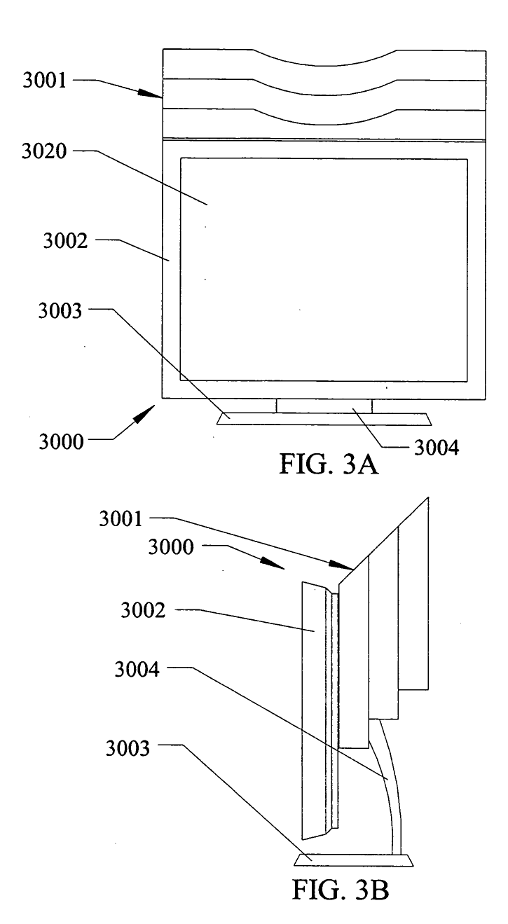

FIGS. 3A and 3B illustrate front and side views, respectively, of a flat panel display assembly 3000 that generally includes an integrated organizer 3001, a display housing 3002, a base 3003, a support 3004, and a display 3020. The support 3004 is attached to the organizer 3001 and the base 3003 as shown. The organizer 3001 includes three receptacles that can be dimensioned in an embodiment to receive standard-sized documents. Each receptacle is positioned against the other in a staggered fashion, such that receptacles proximate the display 3020 are lower relative to receptacles distal the display 3020. The staggered configuration permits the user to access “at-a-glance” documents placed in the organizer 3001 without having to rifle through them.

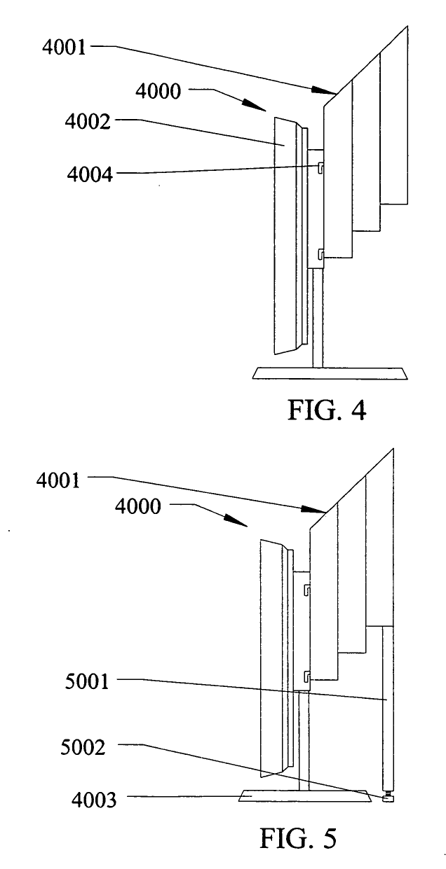

FIG. 4 illustrates a flat panel display assembly 4000 having an organizer 4001 that is removably mounted to a housing 4002 of the flat panel display 4000. In this illustration, hooks 4004 on the organizer 4001 fit into corresponding apertures in the flat panel display housing 4002. In other embodiments, other forms besides the hook-and-hole mounting technique shown in FIG. 4 can be utilized. For example, these other forms can include: Velcro, tongue-and-groove, screws, push pins, removable rivets, adhesive tape, interlocking wedges, and other suitable techniques known to those skilled in the art.

FIG. 5 adds a support post 5001 together with a threaded adjustable footing 5002 that provide further support such that the flat panel display assembly 4000 and the organizer 4001 do not tip over in the event that the weight is not balanced over the base 4003. For example, if a large number of documents are placed in the rearmost receptacle of the organizer 4001 relative to the viewing surface of the flat panel display assembly 4000, the flat panel display assembly 4000 may tend to tip over, undesirably spilling the contents of the receptacles onto the user's working surface.

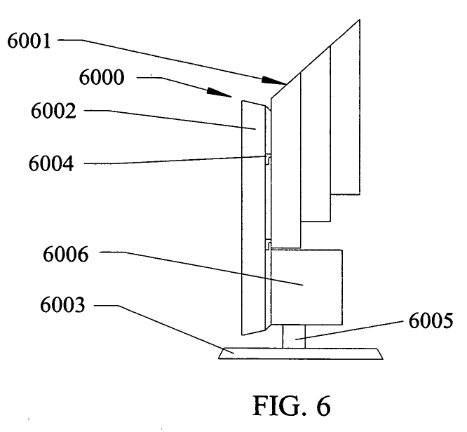

FIG. 6 illustrates a flat panel display assembly 6000 in which some of its electronics have been located in an electronics housing to provide an optimal location of the organizer 6001. The electronics can include any or all of the following: video drive electronics, power supply, batteries, video signal translator boards, connector ports, and other hardware. The electronics housing 6006 is mounted to a stand 6005 and/or to a housing 6002 of the flat panel display assembly 6000 to provide stability for the flat panel display 6000. A hook 6004 and corresponding aperture in a housing 6002 of the flat panel display assembly 6000 removably secures the organizer 6001 thereto.

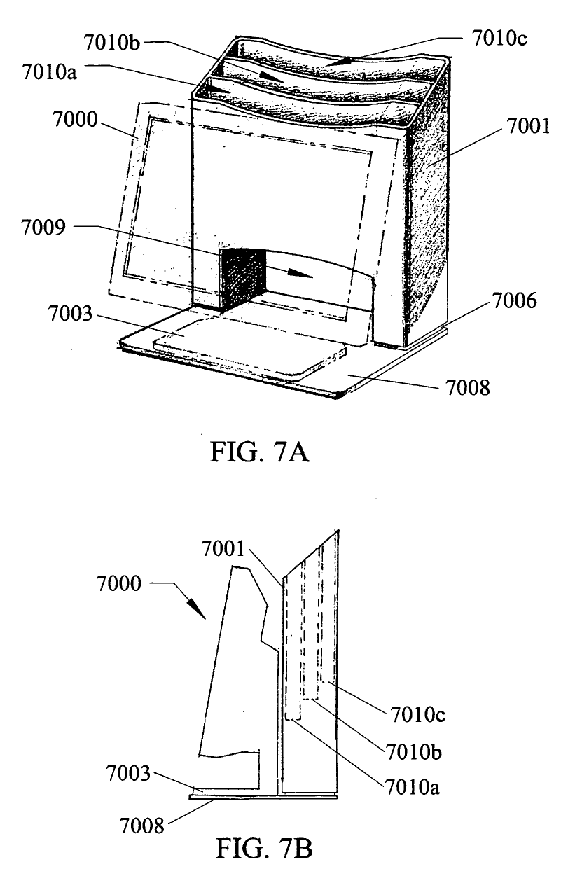

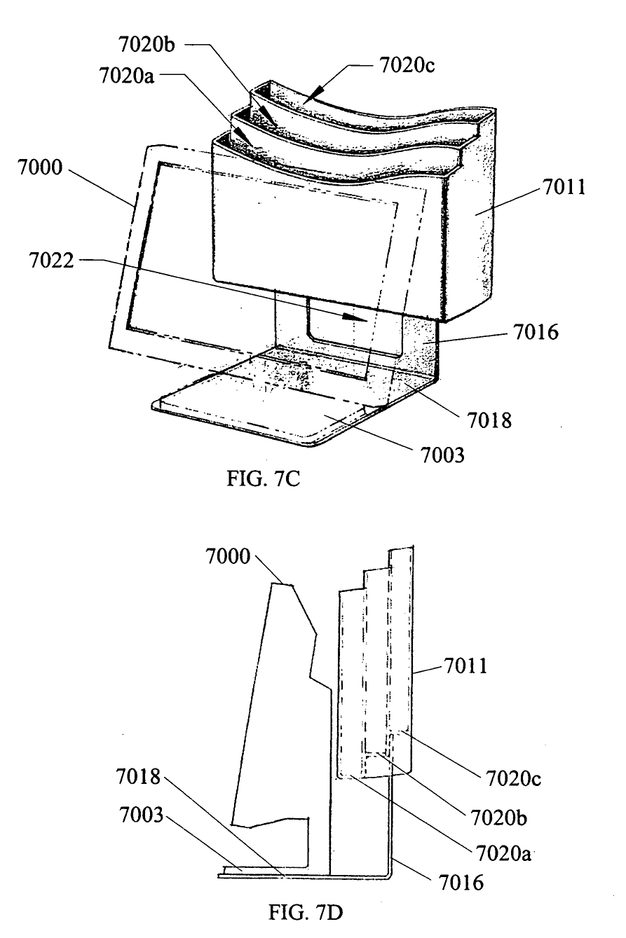

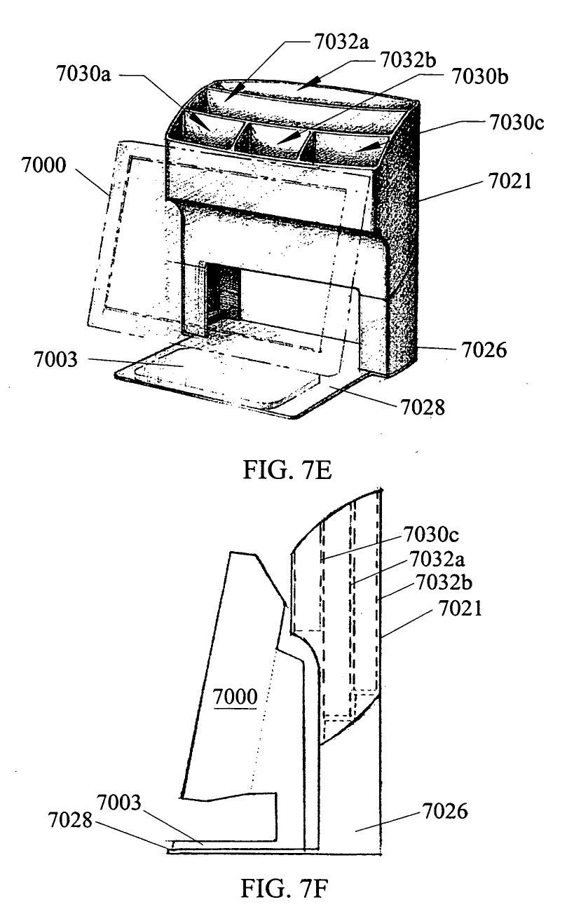

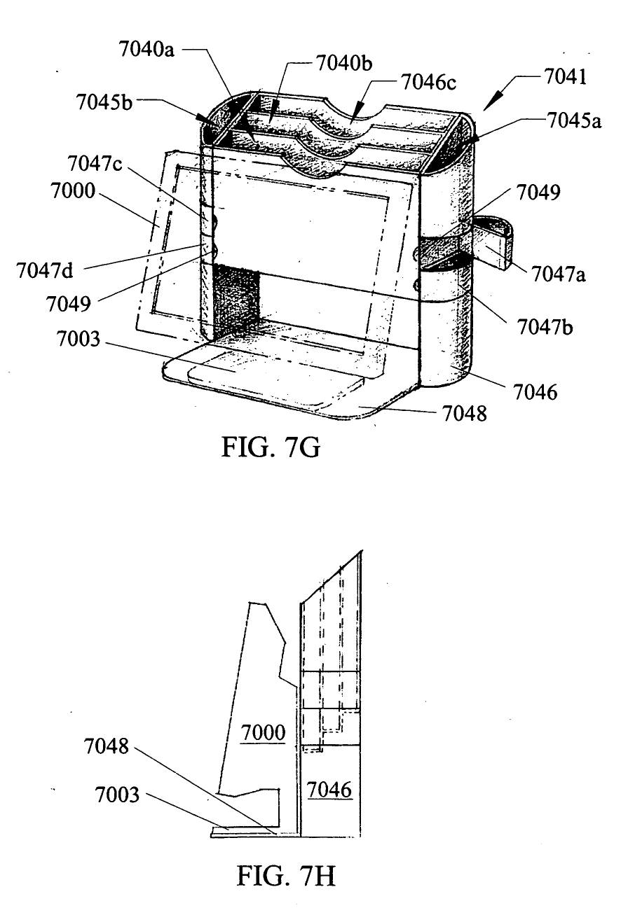

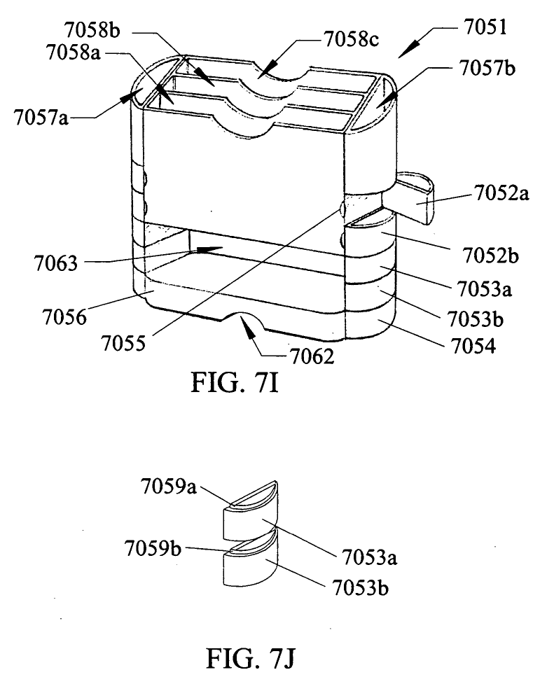

FIGS. 7A and 7B illustrate a perspective and a side view, respectively, of an organizer assembly 7001 that is positioned behind a flat panel display assembly 7000 that includes a base 7003 that rests on a footing 7008 of the organizer assembly 7001. The footing 7008 is removably connected to the organizer assembly 7001 by way of an interconnect 7006. Removing the footing 7008 from the organizer 7001 reduces the size of the assembly and is beneficial for shipping and storage.

The organizer assembly 7001 includes receptacle 7010a, receptacle 7010b and receptacle 7010c that are staggered so that the receptacle 7010c, farthest away from the flat panel display assembly 7000, is higher relative to receptacle 7010a and receptacle 7010b, which are closer to the flat panel display assembly 7000. This staggered arrangement creates a visual height distinction in the documents so that documents placed in one receptacle will be visually distinguishable from documents placed in other receptacles.

The opening 7009 provides a passageway for the electrical cables (not illustrated) of the flat panel display assembly 7000. The cables pass through the opening 7009, above the footing 7008 and under the receptacles 7010a-c. During installation, the organizer assembly 7001 can be separated from the footing 7008 such that the cables can be routed through the opening 7009 without requiring that the cables be disconnected and reconnected. Alternatively, the cables can be routed around the footing 7008 area.

FIGS. 7C and 7D illustrate an embodiment similar to that shown in FIGS. 7A and 7B with a different base and footing arrangement. FIGS. 7C and 7D illustrate a perspective and a side view, respectively, of an organizer 7011 that is positioned behind a flat panel display assembly 7000 that includes a base 7003. The organizer 7011 includes a stand 7016 and a footing 7018. The base 7003 of the flat panel display assembly 7000 rests on the footing 7018. The stand 7016 connects the footing 7018 to the organizer 7011.

The organizer 7011 includes receptacle 7020a, receptacle 7020b and receptacle 7020c that are staggered so that receptacle 7020c, farthest away from the flat panel display assembly 7000, is higher relative to receptacle 7020a and receptacle 7020b, which are closer to the flat panel display assembly 7000. This staggered arrangement creates a visual height distinction in the documents so that documents placed in one receptacle will be visually distinguishable from documents placed in other receptacles.

The opening 7022 provides a passageway for the electrical cables (not illustrated) of the flat panel display assembly 7000. The cables pass through the opening 7022, above the footing 7018 and under the receptacles 7020a-c. Alternatively, the cables can be routed around the footing 7018 and the stand 7016.

FIGS. 7E and 7F illustrate another embodiment similar to that shown in FIGS. 7C and 7D except a stand 7026 is separably connected to a footing 7028 of an organizer 7021. The organizer 7021 is positioned behind a flat panel display assembly 7000 that includes a base 7003. The flat panel display base 7003 rests on a footing 7028 of the organizer 7021. The stand 7026 connects the footing 7028 to the organizer 7021. The stand 7026 is separably connected to the footing 7028 and to the organizer 7021.

The organizer 7021 includes receptacle 7030a, receptacle 7030b, receptacle 7030c, receptacle 7032a and receptacle 7032b. The receptacle 7030a, receptacle 7030b and receptacle 7030c are sized appropriately for holding pencils, pens, staplers, scissors, business cards, compact disks, mobile telephones, and other articles and supplies. Receptacle 7032a and receptacle 7032b are dimensioned to hold standard sized file folders, documents (such as 8.5×11, A4, legal-sized documents) and the like. The receptacles are staggered so that the receptacle 7032b, farthest away from the flat panel display assembly 7000, is higher relative to receptacle 7032a and receptacle 7030a, receptacle 7030b and receptacle 7030c which are closer to the flat panel display assembly 7000. This staggered arrangement creates a visual height distinction in the documents and supplies such that articles placed in one receptacle will be visually distinguishable from articles placed in other receptacles.

FIGS. 7G and 7H illustrate a further embodiment similar to that shown in FIGS. 7E and 7F. FIGS. 7G and 7H illustrate a perspective and a side view, respectively, of an organizer assembly 7041 that is positioned behind a flat panel display assembly 7000 that includes a base 7003 that rests on a footing 7048 of the organizer assembly 7041. The stand 7046, which is attached to a base 7048 of the organizer assembly 7041, is separably connected to the organizer assembly 7041.

The organizer assembly 7041 includes receptacle 7040a, receptacle 7040b, receptacle 7040c, receptacle 7045a and receptacle 7045b. The receptacle 7045a and receptacle 7045b are sized appropriately for holding pencils, pens, staplers, scissors, mobile telephones, and other articles and supplies. Receptacle 7040a, receptacle 7040b and receptacle 7040c are dimensioned to hold standard sized file folders, documents (such as 8.5×11, A4, legal-sized documents), and the like. The receptacles are staggered so that the receptacle 7040c, farthest away from the flat panel display assembly 7000, is higher relative to receptacle 7040a and receptacle 7040b. Receptacle 7045a and receptacle 7045b are positioned beside the receptacle 7040a, receptacle 7040b and receptacle 7040c and provide the user with access to the articles contained within the receptacle 7045a and receptacle 7045b behind and beside the flat panel display 7000. Furthermore, receptacles 7047a-d provide storage for articles including but not limited to stamps, paper clips, thumb tacks, erasers, staples, ink, pencil lead, flash memory and other articles. Some or all of these receptacles can be connected to the organizer assembly 7041 such that they may be opened or closed. The embodiment illustrates receptacle 7047a in an open position. In this embodiment, receptacle 7047a pivots open along a vertical axis shaft (not illustrated). Conversely, it can be movably connected such that it slides, pivots or has an open area above the receptacle 7047a to provide access to the articles housed within the receptacle 7047a. Furthermore, the receptacles 7047a-d can be removable. Finger recesses 7049 provide access to open and close the receptacles 7047a-d.

FIG. 7I illustrates a perspective view of an organizer assembly 7051 that can be positioned behind a flat panel display assembly 7000. In this embodiment, the organizer 7051 is freestanding.

FIG. 7J illustrates an exploded view of the stacking block 7053a and stacking block 7053b that are illustrated in assembled form in FIG. 7I.

Referring to FIGS. 7I and 7J, the organizer assembly 7051 includes base 7056 that is separably connected thereto by way of stacking blocks 7053a and 7053b that have an interlocking flange 7059a and an interlocking flange 7059b, respectively. As shown in the illustration, the interlocking flange 7059b fits snugly into the bottom of the stacking block 7053a. By utilizing the appropriate number of stacking blocks, the height of the organizer assembly 7051 is adjustable for use with flat panel displays of various sizes.

The organizer assembly 7051 includes receptacles 7058a, receptacle 7058b, receptacle 7058c, receptacle 7057a and receptacle 7057b. The receptacle 7057a and receptacle 7057b are sized appropriately for holding pencils, pens, staplers, scissors, mobile telephones, and other articles and supplies. Receptacles 7058a-c are dimensioned to hold standard sized file folders, documents (such as 8.5×11, A4, legal-sized documents), and the like. The receptacles are staggered so that the receptacle 7058c, farthest away from the flat panel display assembly 7000, is higher relative to receptacle 7058a and receptacle 7058b. Receptacle 7057a and receptacle 7057b are positioned beside the receptacle 7058a, receptacle 7058b and receptacle 7058c and provide the user with access to the articles contained within the receptacle 7057a and receptacle 7057b behind and beside the flat panel display. Furthermore, receptacle 7052a and receptacle 7052b provide further storage for articles including but not limited to stamps, paper clips, thumb tacks, erasers, staples, ink, pencil lead, flash memory and other articles. The receptacle 7052a and receptacle 7052b are connected to the organizer assembly 7051 such that they may be opened or closed. The embodiment illustrates receptacle 7052a mounted in a pivot arrangement by a hinge-means; conversely, it can be movably connected such that it slides, pivots or has an open area above the receptacle 7052a to provide access to the articles housed within the receptacle 7052a. Finger recesses 7055 provide access to open and close the receptacle 7052a and receptacle 7047b.

The channel 7062 provides a passageway for the electrical cables (not illustrated) of the flat panel display assembly (not illustrated) to pass under the organizer assembly 7051. Alternatively, these electrical cables can pass through the opening 7063 above the base 7056 and under the receptacles 7058a-c. Furthermore these cables can be routed around the base 7056.

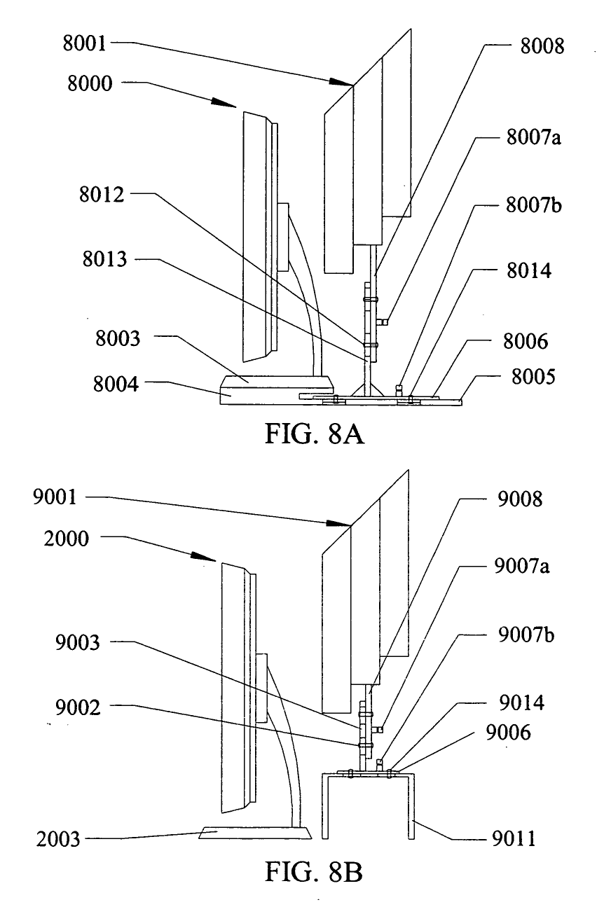

FIG. 8A illustrates an adjustable organizer 8001 such that the user can adjust it to an ideal position to accommodate user preferences and the particular dimensions of a flat panel display assembly 8000. Flat panels come in many different shapes and sizes, and the organizer 8001 shown in FIG. 8A accommodates all such shapes and sizes. The adjustable organizer 8001 of FIG. 8A can be adjusted both horizontally and vertically relative to the flat panel display assembly 8000.

The flat panel display assembly 8000 includes a base 8003 that rests on a footing 8004. The organizer 8001 is adjustable horizontally by way of a sliding base plate 8006. The sliding base plate 8006 can move in and out of the footing 8004 and thereby allow it to be adjusted forward under the flat panel display base 8003. The sliding base plate 8006 moves relative to a fixed base plate 8005 and is guided by pins 8014 fixed to the sliding base plate 8006 that move in corresponding slots formed in the fixed base plate 8005. The sliding base plate 8006 can be locked into position by way of a locking pin 8007b.

Vertical adjustment of the organizer 8001 can be accomplished by sliding an adjustable organizer stand 8008 relative to a fixed organizer stand 8013. Movement is guided by pins 8012 fixed to the adjustable organizer stand 8008 that moves in slots formed in the fixed organizer stand 8013. The adjustable organizer stand 8008 can be locked into position by a locking pin 8007a.

The horizontal and vertical adjustment can be accomplished by any number of other adjustment fastening techniques known in the art. These include, but are not limited to: ratchet fittings, threaded adjusters, racks, pinions, and pin locators.

The configuration shown in FIG. 8B is similar to that of FIG. 8A, except a footing 9011 of an organizer 9001 is freestanding and not attached nor slidable under the flat panel display base 2003 of the flat panel display assembly 2000. The footing 9011 is dimensioned to provide stability to the organizer 9001 even when normally loaded with documents and other things.

The organizer 9001 is adjustable horizontally by way of a sliding base plate 9006. The sliding base plate 9006 moves relative to the footing 9011 and is guided by pins 9014 fixed to the sliding base plate 9006 that move in corresponding slots formed in the footing 9011. The sliding base plate 9006 can be locked into position by way of a locking pin 9007b.

Vertical adjustment can be carried out by sliding an adjustable organizer stand 9008 relative to a fixed organizer stand 9003. Movement is guided by pins 9002 fixed to the adjustable organizer stand 9008 that moves in slots formed in the fixed organizer stand 9003. The adjustable organizer stand 9008 can be locked into position by a locking pin 9007a.

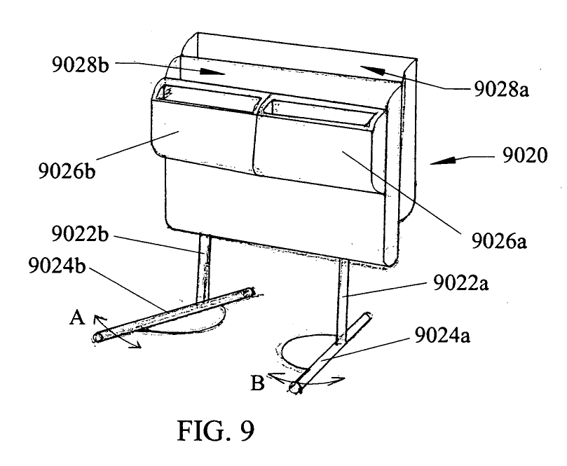

FIG. 9 illustrates a freestanding organizer assembly 9020 for use behind a flat panel display (not illustrated). The organizer includes receptacle 9026a, receptacle 9026b, receptacle 9028a, and receptacle 9028b. Receptacle 9026a and receptacle 9026b are sized appropriately for holding pencils, pens, staplers, scissors, mobile telephones, and other articles and supplies. Receptacle 9028a and receptacle 9028b are dimensioned to hold standard sized file folders, documents (such as 8.5×11, A4, legal-sized documents), and the like. The receptacles are staggered so that the receptacle 9028a is higher relative to receptacle 9028b, receptacle 9026a and receptacle 9026b.

The footing 9024a and footing 9024b of the organizer assembly 9020 can be pivoted in the directions shown by the arrows A and B as shown in the illustration. The variable positions of the footing 9024a and footing 9024b provide for the organizer assembly 9020 to be used behind flat panel displays with a multitude of possible base configurations. The footing 9024a and footing 9024b are connected to the organizer assembly 9020 with stand 9022a and stand 9022b, respectively.

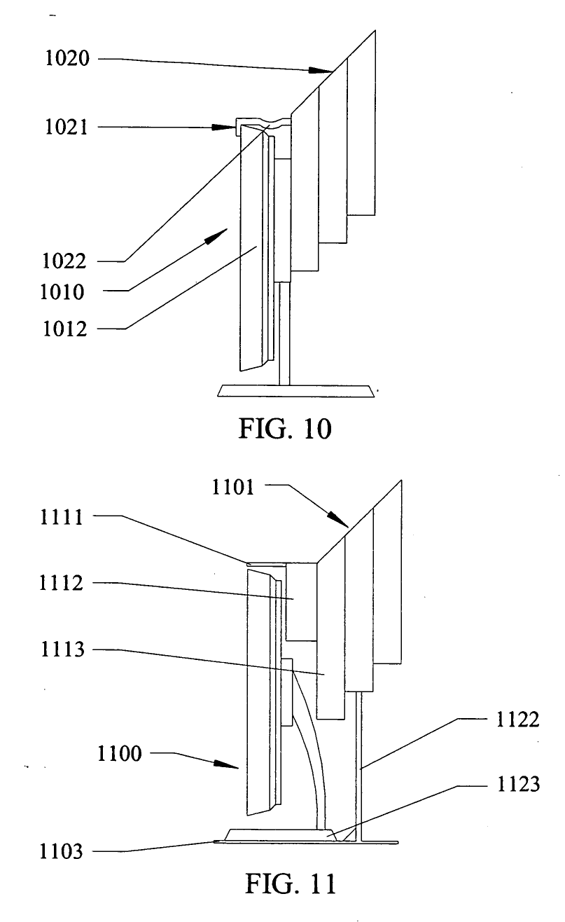

FIG. 10 illustrates a side view of an organizer 1020 mounted by an extension 1022 having a lip 1021 that overhangs the top of a housing 1012 of a flat panel display assembly 1010. Furthermore, the extension 1022 can serve many additional purposes including, but not limited to a storage shelf, a display shelf, pencil tray, and/or a tray for other miscellaneous articles including office supplies. Alternate or additional extensions 1022 and lips 1021 can be used to capture the sides of the housing 1012. Additionally, these extensions 1022 and lips 1021 can be adjustable such that they can adapt to various flat panel display sizes. Furthermore, parts of the organizer 1020 can extend beyond the sides or in front of the viewing side of the flat panel display assembly 1010.

FIG. 11 illustrates an embodiment where an organizer 1101 includes file holders 1113, cups 1112 for holding pencils, pens, staplers, scissors and other supplies, and a shelf 1111 that can be positioned above, beside or behind the flat panel display assembly 1100. The flat panel display 1100 includes a base 1123 that rests on a footing 1103 that is connected to a support 1122 of the organizer 1101. This arrangement advantageously uses the weight of the flat panel display 1100 as a counterweight to the documents and other things that may be placed in the organizer 1101.

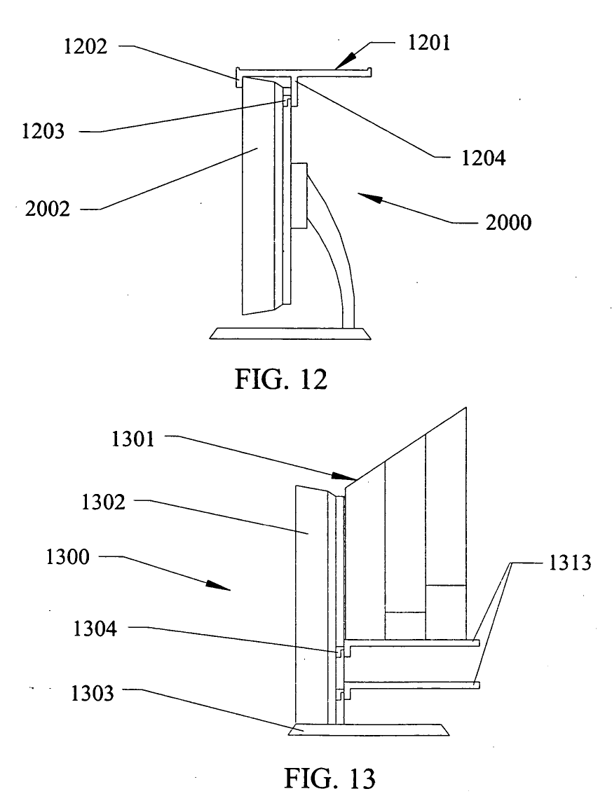

FIG. 12 illustrates a shelf 1201 mounted to the flat panel display 2000 to provide additional storage. The shelf 1201 mounts by clamping to the flat panel display housing 2002 using a forward lip 1202 and a reward lip 1204. Additionally and alternatively, the shelf 1201 can be supported by hooks 1203 that mount into corresponding apertures formed in a housing 2002 of the flat panel display assembly 2000. Alternatively, a resilient member made of a material such as foam or rubber can be situated on the forward lip 1202, on the reward lip 1204, or on both lips to provide a compression force to hold the shelf 1201 in position. Furthermore, adjustable clamps, Velcro, tape, screws, and other fasteners well known to those skilled in the art can be used to permanently or to removably affix the shelf 1201 to the flat panel display assembly 2000.

FIG. 13 illustrates an organizer 1301 positioned on an upper one of organizer shelves 1313 that are removably mounted to the rear portion of a housing 1302 of a flat panel display assembly 1300. The removable shelves 1313 are mounted to the housing 1302 by hooks 1304 that mount into corresponding apertures formed in the housing 1302. In other embodiments, the removable shelves 1313 can be mounted using Velcro, tongue-and-groove, screws, push pins, removable rivets, adhesive tape, interlocking wedges, and any other suitable technique known in the art. Although two removable shelves 1313 are shown, any number of shelves can be used. Similarly, other organizer components such as cups and the like can be removably affixed to the flat panel display assembly 1300. In an embodiment, the shelves 1313 can be integrated into the flat panel display assembly. A base 1303 provides stability to prevent the flat panel display assembly 1300 from tipping over.

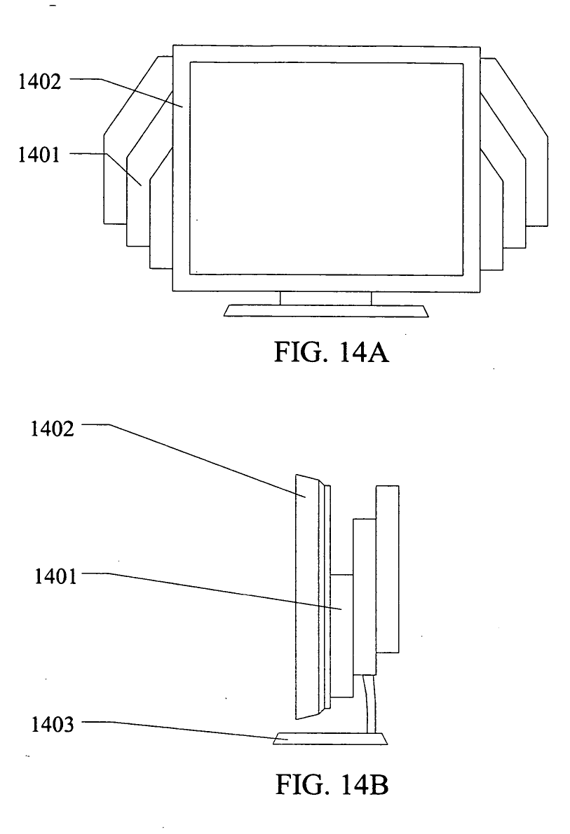

FIGS. 14A and 14B illustrate respective front and side views of an organizer 1401 extending from behind the viewing surface of a flat panel display 1402 to contain and display materials such that the materials are visible beside the flat panel display 1402. The organizer 1401 includes receptacles that are staggered so that the receptacle farthest away from the flat panel display 1402 is higher relative to receptacles closer to the flat panel display 1402. This staggered arrangement creates a visual height distinction in the documents so that documents placed in one receptacle will be visually distinguishable from documents placed in other receptacles.

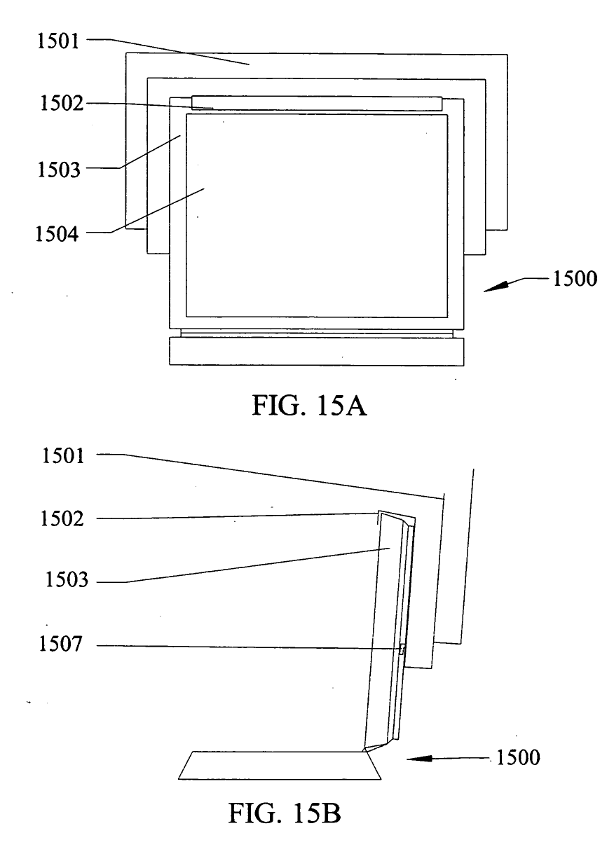

FIGS. 15A and 15B illustrate an organizer 1501 that is mounted on a portable flat panel display assembly 1500. Examples of portable flat panel display assemblies include notebook computers, laptop computers, portable digital video disk players, portable video game players, and other such devices. The organizer 1501 extends from behind a housing 1503 of the portable flat panel display 1504 to contain and display materials such that the materials are visible above and or beside the housing 1503. As shown, the organizer 1501 is mounted by a lip 1502 that overhangs the top of the housing 1503. Furthermore, the lip 1502 can serve many additional purposes including, but not limited to, a storage shelf, pencil tray, or a tray for other miscellaneous articles that may include office supplies. Alternate or additional lips can be used to capture the sides of the housing 1503 in other embodiments. The lip 1502 can be adjustable to adapt to varying flat panel display sizes. For example, some housings are thicker than others. In some embodiments, the lip 1502 is adjustable to accommodate housings of varying thicknesses. Additionally, parts of the organizer 1501 can extend beside (as shown in FIG. 15A) and or in front of the viewing side of the portable flat panel display assembly 1500.

As an alternative or addition to the lip 1502, hooks 1507 (visible in FIG. 15B) on the organizer 1501 that fit into corresponding apertures formed in the housing 1503 of the portable flat panel display assembly 1500 can be used to mount the organizer 1501 to the housing 1503. Alternative forms of the illustrated hook-and-hole mounting technique include: Velcro, tongue-and-groove, screws, push pins, removable rivets, adhesive tape, interlocking wedges, elastic straps, and other similar techniques generally known in the art.

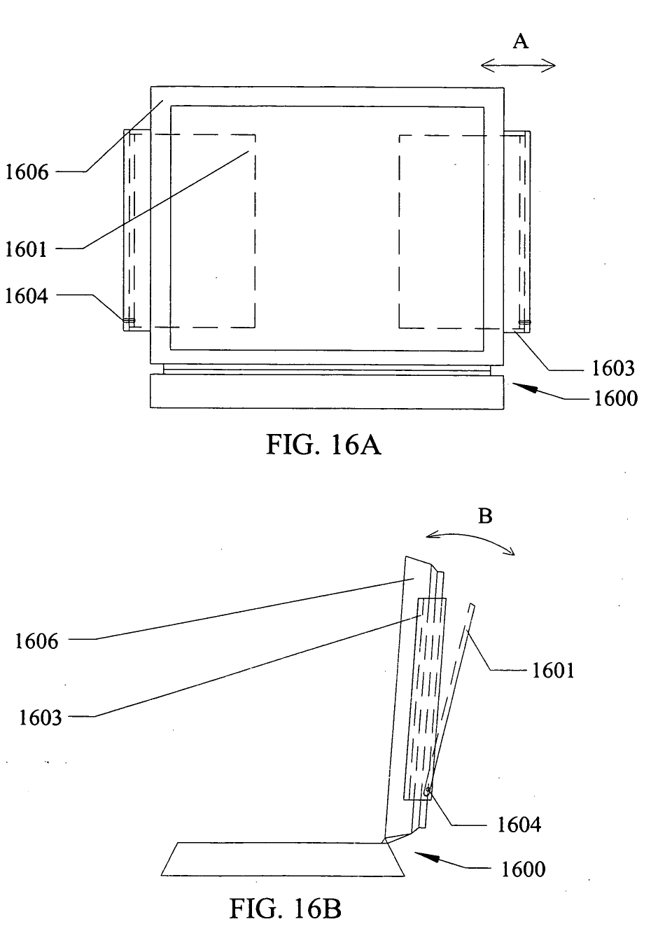

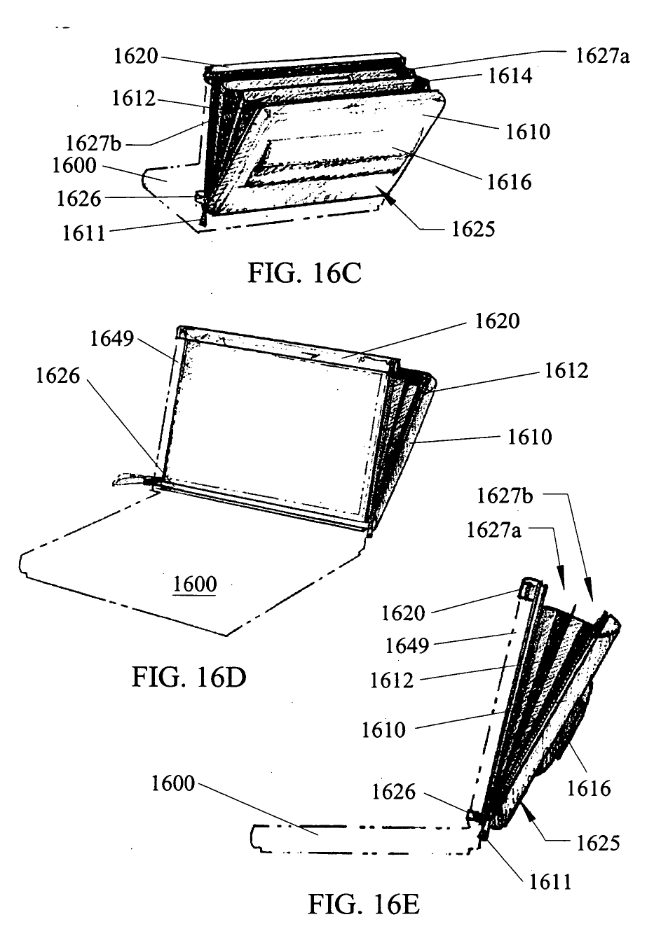

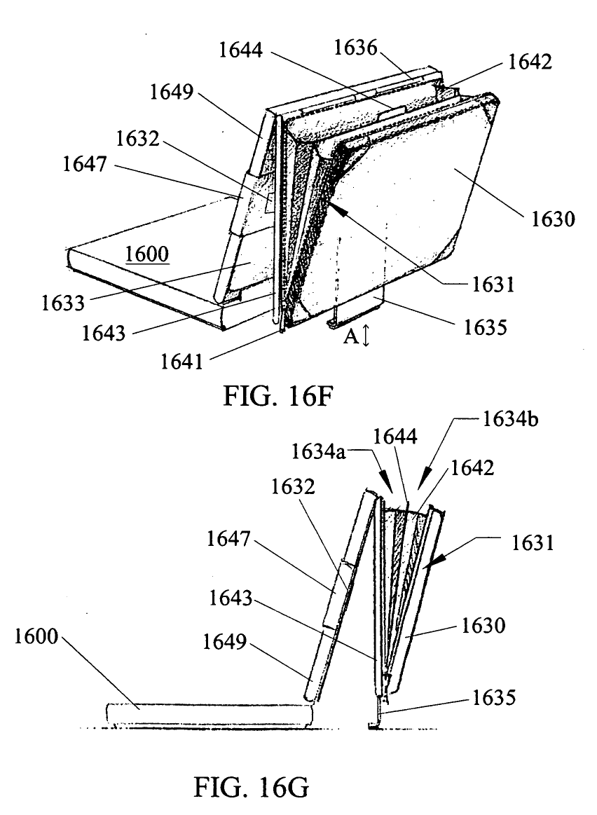

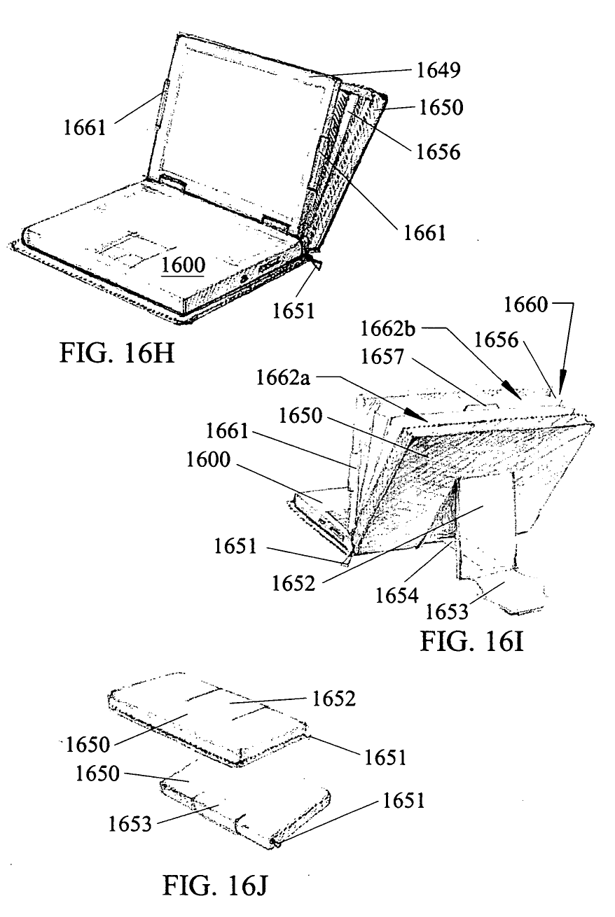

FIGS. 16A and 16B illustrate organizer flanges 1601 that can support file folders and other materials behind a housing 1606 of a portable flat panel display assembly 1600. The organizer flanges 1601 rotate vertically about pivot pins 1604 as shown by arrow B and extend horizontally away from sides of the housing 1606 by way of sliding wings 1603 as shown by arrow A. The sliding wings 1603 are thus adjustable to fit documents of varying widths, file folders, or other materials. The sliding wings 1603 and organizer flanges 1601 retract for storage behind the housing 1606 and when not in use.

The configuration of the organizer flanges 1601 and sliding wings 1603 is ideal for a notebook computer used on an airplane or in the back seat of a car. In this embodiment, the user is able to store files, documents or other materials behind the flat panel display housing 1606 and have direct line-of-sight visibility and easy access while working in the confined space of an airplane seat and tray table. Normally, the user would have to place these documents in the lap or in the seat pocket below the tray table. Given the cramped nature of an airline seat, wrestling with documents and other work materials on an airline can be a stressful, uncomfortable, and undesirable endeavor. The present invention offers solutions to create a comfortable, stress-free, and organized environment within which to work, even on an airline.

FIGS. 16C, 16D and 16E respectively illustrate a perspective back view, perspective front view, and side view, respectively, of an organizer assembly 1625 for use with a portable flat panel display assembly 1600. The organizer assembly 1625 mounts to the flat panel display housing 1649 by way of a sleeve 1620 that fits over the top of the flat panel display housing 1649 and a strap 1626 that affixes the organizer assembly 1625 to the bottom of the flat panel display housing 1649. Both the sleeve 1620 and the strap 1626 are adjustable to fit various sized portable flat panel display assemblies 1600.

The receptacle 1627a and receptacle 1627b provide storage within the organizer assembly 1625 for documents, file folders and the like. A dividing wall 1614 separates the contents of receptacle 1627a and receptacle 1627b. The receptacle 1627a and receptacle 1627b are collapsible by way of accordion-like webbing 1612. Furthermore, a cover 1610 can be closed to capture the articles contained in receptacle 1627a and receptacle 1627b. In the illustration, the cover 1610 is closed by a zipper 1611; however, it can be secured using buckles, straps, snaps, Velcro and any other means known to those skilled in the art.

A pouch 1616 located on the cover 1610 provides further storage for additional articles.

FIGS. 16F and 16G respectively illustrate a perspective back view and a side view, respectively, of an organizer assembly 1631 for use with a portable flat panel display assembly 1600. The organizer assembly 1631 mounts to a housing 1649 of the flat panel display 1600 by way of a carrier plate 1633 and brackets 1647, which fit over the sides of the flat panel display housing 1649. An elastic strap 1632 causes the brackets 1647 to clamp onto the flat panel display housing 1649 and provide a suitable mounting for the organizer assembly 1631 on flat panel display housings of various sizes. The brackets 1647 hold the carrier plate 1633 in place up against the back of the flat panel display housing 1649. The backplate 1643 of the organizer assembly 1631 is mounted by a hinge 1636 to the carrier plate 1633.

The organizer assembly 1631 has a retractable footing 1635 that helps to support the weight of the organizer assembly 1631 and prevents the flat panel display housing 1649 from falling backward under the weight of the organizer assembly 1631 and the articles contained therewithin. The footing 1635 adjusts in the direction shown by the arrows A.

The receptacle 1634a and receptacle 1634b provide storage within the organizer assembly 1631 for documents, file folders and the like. A dividing wall 1644 separates the contents of receptacle 1634a and receptacle 1634b. The receptacle 1634a and receptacle 1634b are collapsible by way of accordion-like webbing 1642. Furthermore, a cover 1630 can be closed to capture the articles contained in the receptacle 1634a and receptacle 1634b. In the illustration, the cover 1630 is secured by a zipper 1641; however, it can be secured using buckles, straps, snaps, Velcro and any other means know to those skilled in the art.

FIGS. 16H and 16I illustrate a perspective front view and perspective back view, respectively, of a portable flat panel display assembly 1600 in its open configuration with an attached carrying case 1650 that contains an organizer assembly 1660. FIG. 16J illustrates perspective closed views of the carrying case 1650.

Referring to FIGS. 16H, 16I and 16J, the organizer assembly 1660 mounts to the flat panel display housing 1649 by way of brackets 1661 that fit over the sides of the flat panel display housing 1649 similar to that shown in FIG. 16F. An elastic strap (not illustrated) causes the brackets 1661 to clamp onto the flat panel display housing 1649 and provide a suitable mounting for the carrying case 1650 and organizer assembly 1660 on flat panel display housings of various sizes.

The carrying case 1650 includes a stand 1652 with a support strap 1654 that helps to support the weight of the organizer assembly 1660 and prevents the flat panel display housing 1649 from falling backward under the weight of the organizer assembly 1660 and the articles contained therewithin. The stand has a closure strap 1653 that attaches the loose end of the stand 1652 to the carrying case 1650 when the carrying case 1650 is closed as shown. The closure strap 1653 attaches to the carrying case 1650 by way of snaps, although other attachment means known to those skilled in the art are equally contemplated.

The receptacle 1662a and receptacle 1662b provide storage within the organizer assembly 1660 for documents, file folders and the like. A dividing wall 1657 separates the contents of each receptacle 1662a and receptacle 1662b. The receptacle 1662a and receptacle 1662b are collapsible by way of accordion-like webbing 1656. Furthermore, the carrying case 1650 can be closed to capture the portable flat panel display assembly 1600 and the articles contained in the receptacle 1662a and receptacle 1662b. In the illustration, the cover 1650 is secured by a zipper 1651; however, it can be secured using buckles, straps, snaps, Velcro and any other means known to those skilled in the art.

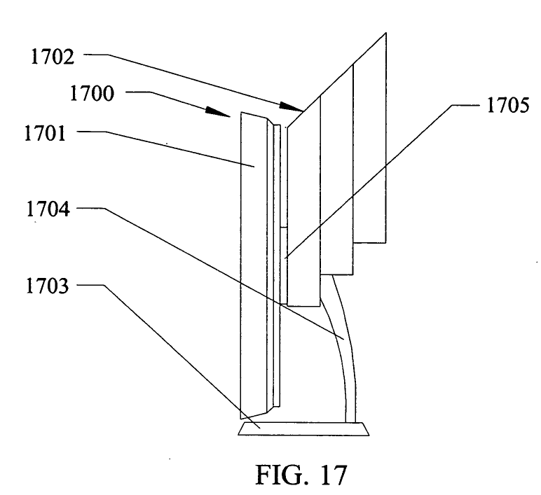

FIG. 17 illustrates a side view of a flat panel display assembly 1700 having a flat panel display housing 1701 that can be rotated from a horizontal landscape orientation to a vertical portrait orientation by way of a rotating coupling 1705. The organizer 1702 is mounted to a support stand 1704 and as such, the organizer 1702 does not rotate and remains stationary when the flat panel display rotates between landscape and portrait orientations. A base 1703 is dimensioned to prevent the flat panel display assembly 1700 from tipping over or becoming unbalanced as materials are placed into the organizer 1702.

Any of the aforementioned organizers can be made from many materials including, but not limited to: plastic, metal, perforated metal, wire form, composites, ceramics, wood, paperboard, cloth, and cardboard. The preferred material for most embodiments is plastic. However, for embodiments in which the organizer is expandable in an accordion-like manner (such as the expandable files made by Pendaflex and others), paperboard or cloth are better-suited materials. In this manner, the organizer is collapsible when not in use and thus requires minimal space for storage and transportation.

It must be noted that any of the aforementioned organizers and the flat panel display assemblies should be configured such that they leave ventilation paths that are needed to keep the flat panel display within operating temperature. Furthermore, the organizer mountings described on the back of the flat panel display are equally effective when installed on the sides of the flat panel display.

As noted above, examples of portable flat panel displays include notebook computers, laptop computers, portable video players, portable video game players, PDAs, and other such devices. These portable flat panel devices can be used in locations where space is limited such as on airplanes or in hotels with small desks. Often, ancillary materials are used with these devices, including: files, documents, notes, compact disks, digital video disks, cords, pens, and the like. Ready access to these materials within the confined space is often necessary and crucial in maximizing productivity. As has been demonstrated in the illustration, an organizer attached to the flat panel display assembly or to the portable device provides this ready access to the materials and optimizes the use of space. An organized workspace creates a more effective working (or playing) environment, allowing the user to accomplish a task with greater comfort, ease, and speed.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A freestanding organizer device for use with a flat panel display assembly, comprising:
at least one receptacle adapted to hold things substantially within said at least one receptacle;
at least one support structure coupled to said at least one receptacle; and
a base attached to said at least one support structure, a portion of said base extending away from said at least one receptacle, wherein said at least one receptacle is positioned on said at least one support structure such that when said flat panel display assembly is positioned on said base and generally in front of said at least one receptacle, said at least one receptacle is accessible over a top portion of said flat panel display assembly.

2. The device of claim 1, wherein said base includes at least one movable footing.

3. The device of claim 1, wherein said at least one receptacle is exactly three receptacles.

4. The device of claim 1, wherein said at least one receptacle is dimensioned to receive an 8.5×11-sized paper.

5. The device of claim 1, wherein said at least one receptacle is made of a material selected from the group consisting of plastic, wood, metal, perforated metal, wire form, paperboard, cardboard, vinyl, cloth, and elastic.

6. The device of claim 1, wherein said at least one receptacle is removable from said organizer device.

7. The device of claim 1, further comprising at least one cup receptacle movably attached to a portion of said at least one support structure.

8. The device of claim 1, further comprising at least one cup receptacle removably coupled to said at least one receptacle.

9. The device of claim 1, wherein said at least one support structure is exactly two support structures.

10. The device of claim 1, wherein said at least one receptacle is at least two receptacles, a first of said at least two receptacles being staggered relative to a second of said at least two receptacles and positioned such that said first receptacle is lower relative to said second receptacle and proximate a user of said flat panel display assembly relative to said second receptacle.

11. The device of claim 1, wherein said at least one support structure is height-adjustable.

12. The device of claim 1, wherein said at least one support structure is stackable relative to said base.

13. The device of claim 1, further comprising at least one shelf removably coupled to said at least one receptacle, said at least one shelf extending across the top of said flat panel display assembly when said flat panel display assembly is positioned on said base.

14. The device of claim 1, wherein said at least one receptacle extends beyond sides of said flat panel display assembly when said flat panel display assembly is positioned on said base, said at least one receptacle being accessible from said sides.

15. The device of claim 1, wherein said base includes a channel formed along a bottom surface thereof for running cables therethrough.

16. A method for holding things, comprising:
providing a freestanding organizer assembly having at least one receptacle adapted to hold said things within said at least one receptacle; and
positioning said freestanding organizer so that at least a portion of said at least one receptacle is behind a flat panel display assembly.

17. The method of claim 16, further comprising adjusting a height of said freestanding organizer by moving an adjustable organizer stand relative to a fixed organizer stand of said freestanding organizer assembly.

18. The method claim 16, further comprising adjusting a height of said freestanding organizer by attaching at least one stacking block to said freestanding organizer assembly.

19. The method of claim 16, further comprising removing said at least one receptacle from said freestanding organizer assembly.

20. The method of claim 16, further comprising attaching a second receptacle to said freestanding organizer assembly adjacent to said at least one receptacle.

21. The method of claim 16, further comprising positioning said flat panel display assembly on a base of said freestanding organizer.

22. The method of claim 16, further comprising expanding said at least one receptacle to increase the interior volume thereof.

23. The method of claim 16, further comprising attaching at least one shelf to said at least one receptacle such that said shelf overhangs the top of said flat panel display assembly.

24. The method of claim 16, further comprising attaching a cup receptacle to said at least one receptacle.

25. The method of claim 24, further comprising inserting an office supply item into said cup receptacle.

26. The method of claim 25, wherein said office supply item is selected from the group consisting of pencils, pens, staplers, scissors, and paper and binder clips.

27. The method of claim 24, further comprising dimensioning said at least one receptacle to hold an object generally having the size and shape of a DVD, a cellular telephone, or a remote control.

28. The method of claim 16, further comprising inserting dimensioning said at least one receptacle to hold a document.

29. The method of claim 16, further comprising extending said at least one receptacle away from a side of said flat panel display assembly such that said things are accessible from said side of said flat panel display assembly, said side being distinct from a top and a bottom of said flat panel display assembly.

30. The method of claim 16, further comprising running cables of said flat panel display assembly through an opening formed in said freestanding organizer.

31. The method of claim 16, further comprising running cables of said flat panel display assembly around said freestanding organizer.

32. A flat panel display assembly having a housing, comprising an organizer assembly having at least one receptacle adapted to hold things substantially within said at least one receptacle, said organizer assembly including means for mounting said at least one receptacle to said housing.

33. The flat panel display assembly of claim 32, wherein said at least one receptacle is mounted behind said flat panel display assembly.

34. The flat panel display assembly of claim 32, wherein said at least one receptacle is mounted beside said flat panel display assembly.

35. The flat panel display assembly of claim 32, further comprising a recloseable cover substantially enclosing said flat panel display assembly when in a closed position.

36. The flat panel display assembly of claim 32, further comprising a recloseable cover substantially enclosing said organizer assembly when in a closed position.

37. The flat panel display assembly of claim 35, wherein said recloseable cover includes a storage pouch.

38. The flat panel display assembly of claim 32, further comprising at least one support structure attached to said organizer assembly.

39. The flat panel display assembly of claim 38, further comprising a base attached to said at least one support structure.

40. The flat panel display assembly of claim 32, wherein said means for mounting is removable.

41. The flat panel display assembly of claim 32, wherein said means for mounting is integral.

42. The flat panel display assembly of claim 32, wherein said organizer assembly is removable from said at least one receptacle via said means for mounting.

43. The flat panel display assembly of claim 32, wherein said organizer assembly is integral with said at least one receptacle.

44. The flat panel display of claim 32, wherein said means for mounting includes a hook-and-hole configuration, a tab-and-slot configuration, a keyhole, a snap-fit configuration, a threaded fastener, a push-pin rivet, a groove-and-slot configuration, an interlocking wedge, adhesive, adhesive tape, tether, Velcro, or elastic bands.

45. The flat panel display of claim 32, wherein said means for mounting includes a hook that overhangs a housing of said flat panel display assembly.

46. The flat panel display assembly of claim 32, wherein said flat panel display assembly is a laptop.

47. The flat panel display assembly of claim 32, wherein said flat panel display assembly is a game player.

48. The flat panel display assembly of claim 32, wherein said flat panel display assembly is a portable video player.

49. The flat panel display assembly of claim 32, wherein said flat panel display is rotatable between a portrait position and a landscape position without rotating said organizer assembly.

50. The flat panel display assembly of claim 32, wherein said at least one receptacle is made of a material selected from the group consisting of plastic, wood, metal, perforated metal, wire form, paperboard, cardboard, vinyl, cloth, and elastic.

51. The flat panel display assembly of claim 32, further comprising means for adjusting a height of said organizer assembly.

52. The flat panel display assembly of claim 32, wherein said at least one receptacle is dimensioned to receive an 8.5×11-sized paper.

53. The flat panel display assembly of claim 32, wherein said at least one receptacle is removable from said organizer device.

54. The flat panel display assembly of claim 32, further comprising at least one cup receptacle movably attached to a portion of said at least one support structure.

55. The flat panel display assembly of claim 32, further comprising at least one cup receptacle attached to said at least one receptacle.

56. The flat panel display assembly of claim 32, wherein said at least one receptacle is at least two receptacles, a first of said at least two receptacles being staggered relative to a second of said at least two receptacles and positioned such that said first receptacle is lower relative to said second receptacle and proximate a user of said flat panel display assembly relative to said second receptacle.

57. The flat panel display assembly of claim 32, further comprising at least one support structure that is height-adjustable.

58. The flat panel display assembly of claim 32, further comprising at least one shelf coupled to said at least one receptacle, said at least one shelf extending across the top of said flat panel display assembly when said flat panel display assembly is positioned on said base.

59. The flat panel display assembly of claim 32, wherein said at least one receptacle extends beyond sides of said flat panel display assembly when said flat panel display assembly is positioned behind said flat panel display assembly, said at least one receptacle being accessible from said sides.

60. A freestanding organizer device for use with a flat panel display assembly, comprising:
at least one receptacle adapted to hold things substantially within said at least one receptacle;
at least one support structure coupled to said at least one receptacle; and
a base attached to said at least one support structure, a portion of said base extending away from said at least one receptacle, wherein said at least one receptacle is positioned on said at least one support structure.
